(19) United States
(12) Patent Application Publication
(10) Pub. No.: US 2008/0086932 A1
(43) Pub. Date: Apr. 17, 2008

(54) Insect-attraction apparatus

(76) Inventors: Peter J. Cook, Issaquah, WA (US); Nathaniel G. Gudz, North Bend, WA (US)

Correspondence Address: OLYMPIC PATENT WORKS PLLC, P.O. BOX 4277, SEATTLE, WA, 98104, US

(21) Appl. No.: 11/580,437

(22) Filed: Oct. 13, 2006

(51) Int. Cl. A01M 1/14; A01M 1/10; A01M 1/02; A01M 1/20

(52) U.S. Cl. 43/114; 43/107; 43/131

(57) ABSTRACT

Various embodiments of the present invention are directed to insect-attraction apparatuses and methods of fabricating and using such apparatuses. One embodiment of an insect-attraction apparatus includes a lure containing an insect-attractive substance. The insect-attraction apparatus also includes a housing having a chamber, with the lure positioned inside the chamber. The chamber is partially defined by a bond between interior surfaces of the housing. When the bond is severed, the housing may be expanded to form a passageway that allows access to the lure.

### TECHNICAL FIELD

The present invention relates to an insect-attraction apparatus. More particularly, the present invention relates to an insect-attraction apparatus including a housing that seals around a lure when the housing is in a storage configuration.

### BACKGROUND OF THE INVENTION

Insect traps have a variety of uses in research, agriculture, pest management, and government-agency-provided services. Insect traps are used for monitoring the sizes and dynamics of insect populations, as well as for killing insects that are harmful to agriculture, domesticated animals, and human health.

One currently available insect trap used for fruit fly monitoring and control is commonly known as a “Jackson Trap.” One Jackson Trap design includes five separate components: (1) a lure; (2) a small plastic basket for holding the lure; (3) a wire hanger on which the small plastic basket is hung; (4) a paperboard-triangular housing that is slid onto the wire hanger and encloses the plastic basket; and (5) a paperboard insert having an adhesive surface capable of capturing insects, such as fruit flies. Typically, the five separate components of the Jackson Trap are individually packaged. Additionally, each of the five components of the Jackson Trap is typically individually acquired and stored by an end user.

Accordingly, Jackson Traps can be expensive, the packaging of the individual components can result in a significant amount of material waste, and the individual components can be tedious to assemble. Therefore, researchers, vendors, government agencies, and individuals that use insect traps continue to seek effective, but less complex insect traps.

### SUMMARY OF THE INVENTION

Various embodiments of the present invention are directed to insect-attraction apparatuses and methods of fabricating and using such apparatuses. One embodiment of an insect-attraction apparatus includes a lure containing an insect-attractive substance. The insect-attraction apparatus further includes a housing having a chamber, with the lure positioned inside the chamber. The chamber is partially defined by a bond between interior surfaces of the housing. When the bond between the interior surfaces is severed, the housing may be expanded to form a passageway that allows access to the lure.

### BRIEF DESCRIPTION OF THE DRAWINGS

FIG. 1 is perspective view of an insect-attraction apparatus, including a housing in a deployment configuration, in accordance with one embodiment of the present invention.

FIG. 2A is a side view of the insect-attraction apparatus shown in FIG. 1.

FIG. 2B is a front view of the insect-attraction apparatus shown in FIG. 1.

FIG. 3 is a perspective view of the insect-attraction apparatus shown in FIG. 1, with an insect-capture sheet positioned within a passageway of the insect-attraction apparatus, in accordance with another embodiment of the present invention.

FIG. 4 is partial bottom view of a base of an insect-attraction apparatus, the base including a serial number and various entry regions for recording information, in accordance with yet another embodiment of the present invention.

FIG. 5A is a plan view of the sheet used to form the housing shown in FIG. 1 before the sheet is folded to form a storage configuration.

FIG. 5B is a side view of FIG. 5A.

FIG. 6A is a side view of the insect-attraction apparatus shown in FIG. 1 folded to form the storage configuration in accordance with one embodiment of the present invention.

FIG. 6B is a cross-sectional view taken along line A-A shown in FIG. 6A.

FIG. 7A is an exploded, perspective view of an insect-attraction apparatus, including a lure-support device having a gripping member, in accordance with another embodiment of the present invention.

FIG. 7B is a front cross-sectional view of the insect-attraction apparatus, shown in FIG. 7A, assembled.

FIG. 8 is a front view of an insect-attraction apparatus in accordance with yet another embodiment of the present invention.

FIG. 9 is a front view of an insect-attraction apparatus in which a lure is attached to an interior surface of the housing in accordance with another embodiment of the present invention.

### DETAILED DESCRIPTION OF THE EMBODIMENTS

Various embodiments of the present invention are directed to insect-attraction apparatuses including a housing having a chamber formed by a bond between interior surfaces of the housing, with a lure sealed inside the chamber. By pulling the interior surfaces of the housing apart, the bond may be severed and the housing may be expanded to form a passageway that allows insects access to the lure through the passageway.

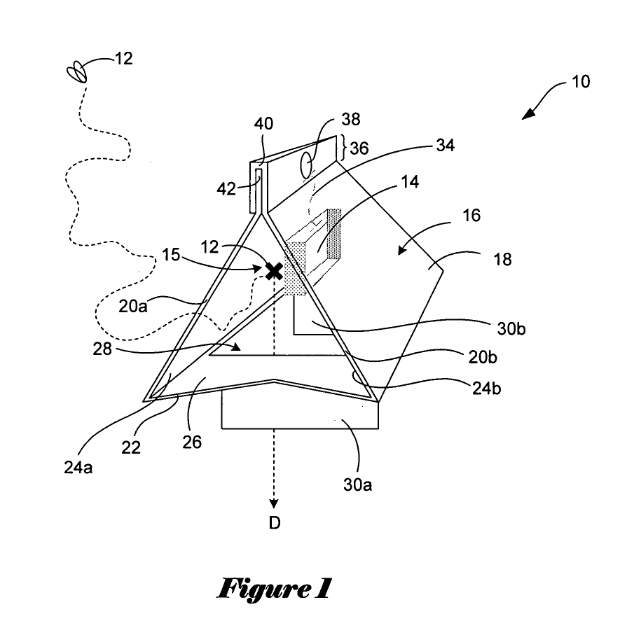

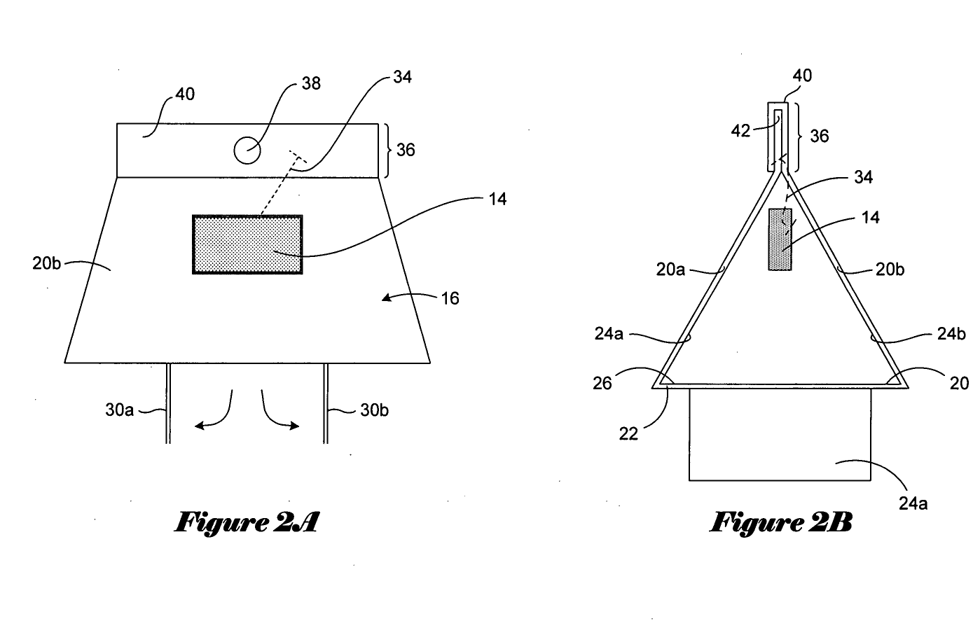

FIGS. 1 and 2A-2B show an insect-attraction apparatus 10 in accordance with one embodiment of the present invention. The insect-attraction apparatus 10 is illustrated in a deployment configuration that allows an insect 12, such as a fruit fly, to access a lure 14 located within a passageway 15 of the insect-attraction apparatus 10. The lure 14 includes an insect-attractive substance for attracting the insect 12 into the passageway 15 so that the insect 12 may be captured with an insect-capture sheet (not shown in FIGS. 1 and 2A-2B). The lure 14 may also include an insecticide for killing the insect 12. The insect-attraction apparatus 10 includes a housing 16 that may be made from a single sheet 18 formed from a material, such as paperboard coated with polyethylene, cardboard, a flexible plastic, a composite laminate, a thin metallic sheet, paper, or another suitable foldable material. The housing 16 includes first and second sidewall members 20a and 20b integrally formed with a base 22. The first and second sidewall members 20a and 20b each includes corresponding first and second interior surfaces 24a and 24b, and the base 22 includes an interior base surface 26. The lure 14 may be attached to the housing 16 by a flexible, plastic string 34 (e.g., a fastener used with currently available tagging guns) or any other suitably configured attachment member that can position the lure 14 within the passageway 15.

In one embodiment of the present invention, the lure 14 may be formed from a polymeric material, such as an acrylic matrix reinforced with fiberglass, that incorporates an insect-attractive substance. The insect-attractive substance may include one or more semiochemicals for attracting various types of fruit flies. A variety of insect-attractive substances and lures are commercially available from Farma Tech International Corporation of North Bend, Wash. The insect-attractive substance may also be a dye of a selected color, or another substance tailored to attract a particular type of insect 12. The lure 14 may also include an insecticide formulated to kill one or more specific types of insects 12. However, in another embodiment of the present invention, a separate insecticide, such as a strip including an insecticide, may be used in combination with the lure 14 and attached to the one of the interior surfaces 24a and 24b of the housing 16.

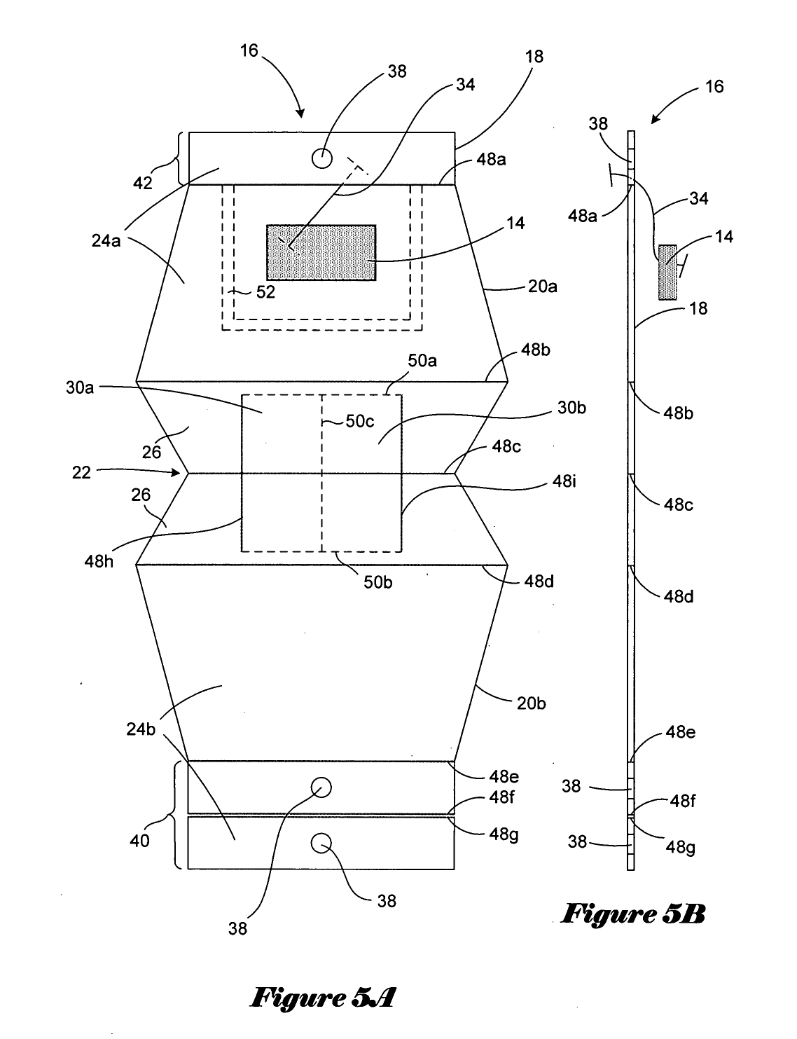

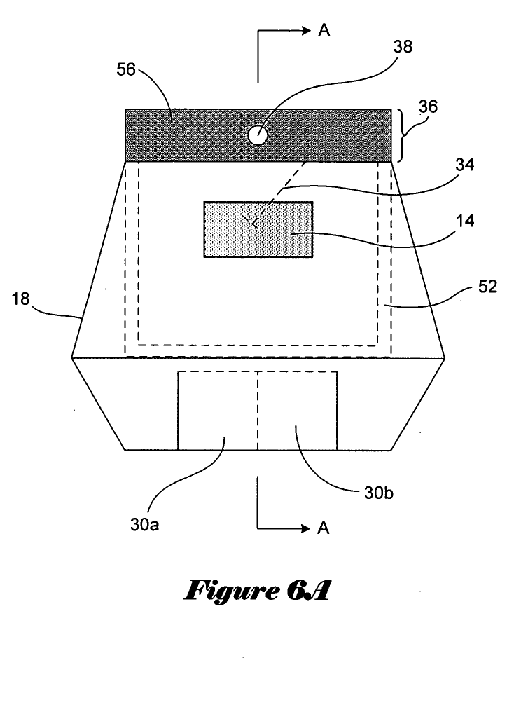

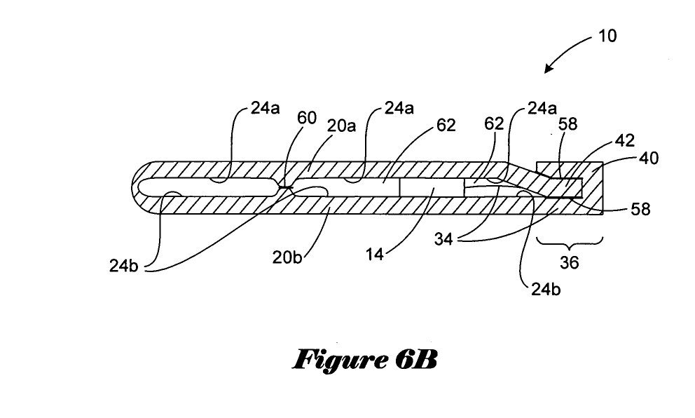

The housing 16 may be formed by folding the single sheet 18 along a number of fold lines (FIGS. 5A and 5B) to define the geometry of the passageway 15 of the housing 16. The passageway 15 is predominately defined by the interior surfaces 24a-24b of the sidewall members 20a-20b and the interior base surface 26 of the base 22. The passageway 15 allows one or more of the insects 12 to fly through the passageway 15 to access the lure 14. Although the passageway 15 is illustrated as having a triangular-shaped cross-sectional geometry, the cross-sectional geometry of the passageway 15 may exhibit a variety of other different cross-sectional geometries, such as a rectangular cross-sectional geometry, diamond cross-sectional geometry, or circular cross-sectional geometry, depending on the manner in which the sheet 18 is folded. Embodiments of methods of the present invention for fabricating the housing 16 will be discussed in more detail below with respect to FIGS. 5A-5B and 6A-6B.

The base 22 further includes an opening 28 extending through the base 22. Tabs 30a and 30b of the base 22 may be manually folded in a direction away from the lure 14 to open the opening 28 and manually folded in a direction toward the lure 14 to close the opening 28. The opening 28, located below the lure 14, allows insects 12 killed by an insecticide incorporated into the insect-attraction apparatus 10 to fall downwardly through the opening 28 along a path D to the ground. Folding the tabs 30a and 30b in a downward direction to open the opening 28 also helps stiffen the base 22.

The housing 16 may also include a top portion 36 spaced apart from the base 22. The top portion 36 may include a hole 38 that allows the housing 16 to be hung by inserting a suitable support structure, such as a hook, within the hole 38. However, in other embodiments of the present invention, the hole 38 may be omitted and the top portion 36 or another portion of the housing 16 may be gripped by a clap or another suitable gripping mechanism. The top portion 36 may include overlapping portions 40 and 42, extending from the sidewall members 20a and 20b, that may be secured to each other. The portion 40, extending from and integrally formed with the sidewall member 20b, may be folded around and secured to the portion 42. The portion 42 extends from and is integrally formed with the sidewall member 20a. In one embodiment of the present invention, when the sheet 18 is made from paperboard or cardboard, the overlapping portions 40 and 42 may be bonded to each other using a heat-sealing process. In other embodiments of the present invention, the overlapping portions 40 and 42 may be bonded to each other using an adhesive, such as glue or another suitable adhesive, placed between the overlapping portions 40 and 42.

In a further embodiment of the present invention, the tab portion 36 may be omitted and a portion of the sidewall member 20a may overlap a portion of the sidewall member 20b or vice versa. In another embodiment of the present invention, the housing 16 may be integrally formed from a blow-molded, single piece of polymeric material. In such an embodiment, a joining process, such as heat-sealing, is not required to construct the housing 16.

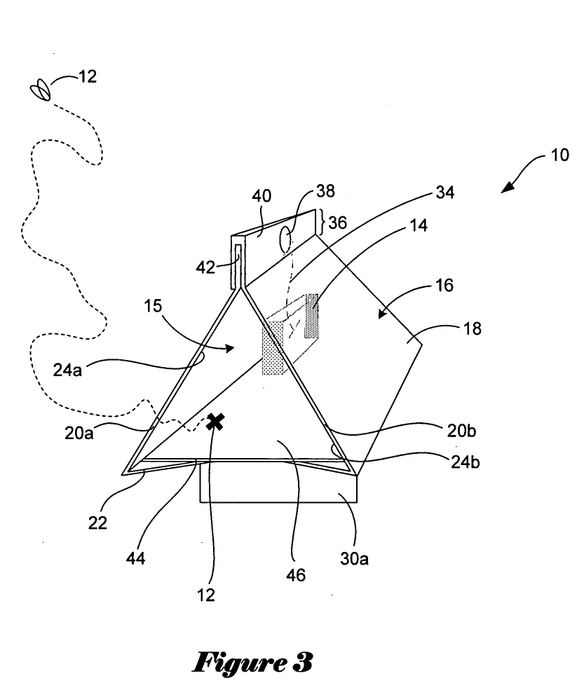

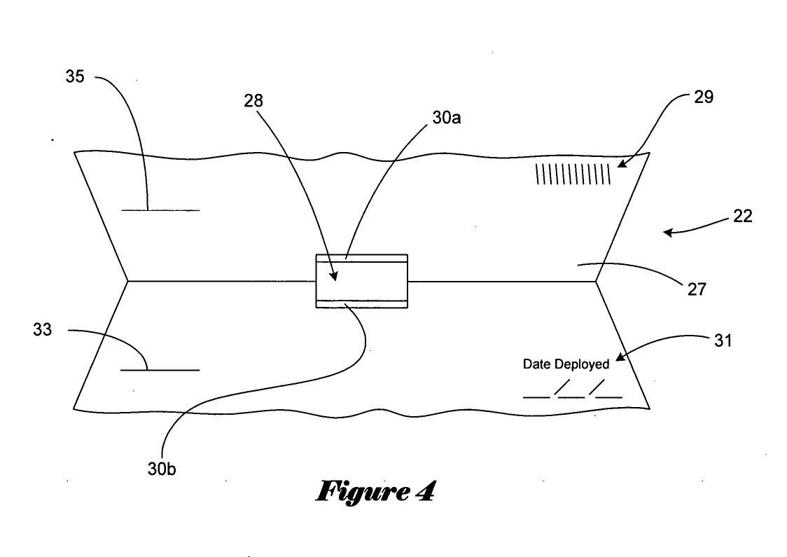

In another embodiment of the present invention shown in FIG. 3, an insect-capture sheet 44 may be positioned within the passageway 15 and supported by the base 22. In this embodiment, the lure 14 does not include an insecticide. The insect-capture sheet 44 may be used to collect one or more of the insects 12 that are attracted into to the lure 14 within the passageway 15. The insect-capture sheet 44 includes an adhesive surface 46 so that when one of the insects 12 (e.g., a fruit fly) lands on the adhesive surface 46, the insect 12 is retained on the insect-capture sheet 44. Therefore, the insect-capture sheet 44 may be used for collecting samples of the insects 12 that may be prevalent in an area to ascertain if fruit flies or other deleterious insects are present. In the illustrated embodiment shown in FIG. 3, the tabs 30a and 30b may be omitted because the insects 12 are captured on the insect-capture sheet 44. As one example, government agricultural agencies may examine the insects 12 that are captured on the insect-capture sheet 44 in order to be able to certify fruit grown in their jurisdictions as Mediterranean-fruit-fly free, and therefore eligible for export to regions and countries that prohibit importation of fruit from Mediterranean-fruit-fly-infested regions.

In yet another embodiment of the present invention shown in FIG. 4, a bottom surface 27 of the base 22 or another surface of the housing 16 may include a unique serial number 29. The serial number 29 may be a barcode or another suitable code. In addition to the unique serial number 29, the back surface 27 may also include a date-entry region 31 for a technician deploying the insect-attraction apparatus 10 in the field to enter the date that the insect-attraction apparatus 10 is deployed. The date-entry region 31 may include regions for recording the day, date, and year that the insect-attraction apparatus 10 is deployed. A time-entry region 33 may also be provided to enter the time that the insect-attraction apparatus 10 is deployed. A location-entry region 35 may also be provided for entering the location of the insect-attraction apparatus 10. The unique serial number 29, the date recorded in the date-entry region 31, the time recorded in the time-entry region 33, and the location of the particular insect-attraction apparatus 10 may be entered into a database. The location of the insect-attraction apparatus 10 may be ascertained using global positioning system measurements. In some embodiments of the present invention, the type of insects 12 killed or captured by the insect-attraction apparatus 10 may also be input into the database and associated with the other information about the particular insect-attraction apparatus 10. In yet another embodiment of the present invention, at least one of the unique serial number 29, date deployed, and location of the insect-attraction apparatus 10 may be stored in a radio-frequency-identification (“RFID”) tag embedded within the housing 16 or otherwise attached to the housing 16.

Various embodiments of methods of the present invention are described with reference to FIGS. 5A and 5B. FIGS. 5A and 5B show a plan view of the sheet 18 and lure 14 prior to the sheet 18 being folded and expanded to form the housing 16 shown in FIGS. 1 and 2A-2B. The sheet 18 may be easily cut to shape from paperboard, cardboard, a flexible plastic, a composite laminate, a thin metallic sheet, paper, or another suitable foldable material. The sheet 18 may be die cut and, concurrently with die cutting, fold lines or score lines 48a-48i may be formed on the sheet 18 to facilitate folding the sheet 18 along the fold lines 48a-48i to form the particular configuration for the housing 16 shown in FIGS. 1 and 2A-2B. The sheet 18 may also include perforations 50a-50c that partially outline the opening 28 formed in the base 22, and when broken allow the tabs 30a and 30b to be deployed. In other embodiments of the present invention, instead of providing the fold lines 48h and 48i, perforations may be provided in the same location, and the tabs 30a and 30b may be removed from the base 22 to form the opening 28. In yet another embodiment of the present invention, the opening 28 may be cut in the sheet 18 prior to folding.

As shown in FIG. 5B, one end of the plastic string 34 may be inserted through a portion of the sheet 18 to secure the lure 14 to the sheet 18. After cutting the sheet 18 to shape, forming the fold lines 48a-48i and the perforations 50a-50c, and inserting the string 34 through the sheet 18, the sheet 18 is folded. The sheet 18 is folded along the fold line 48c of the base 22 so that the interior surface 24a and the interior surface 24b sandwich the lure 14 between each other. The interior surfaces 24a and 24b also mate with each other in areas surrounding the periphery of the lure 14. Next, the portion 40 is folded about the fold lines 48f and 48g so that it overlaps with the portion 42 and the holes 38 formed in the portions 40 and 42 generally align with each other.

Then, as shown in FIGS. 6A and 6B, the interior surfaces 24a and 24b of the sheet 18 may be bonded to each other along a bond region 56 (FIG. 6A) to form bonds 58 (FIG. 6B). The interior surfaces 24a and 24b of the sheet 18 may also be bonded to each other along a bond region 52, which may extend partially or completely about the lure 14, to form a bond 60 (FIG. 6B). The bond 60 may be formed after, concurrently with, or before forming the bonds 58. According to certain embodiments of the present invention, the bonds 58 and 60 may be formed using a heat-sealing process. Heat-sealing is particularly effective when the sheet 18 is made from paperboard and cardboard. Forming the bonds 58 and 60 substantially seals the lure 14 within a chamber 62 of the housing 16. The chamber 62 is defined by the bond 60, interior surfaces 24a and 24b of the sheet 18, and bond 58. The lure 14, which may be toxic due to the presence of insecticides and/or odorous due to the presence of semiochemicals, is contained within the chamber 62. The bonds 58 and 60 and the interior surfaces 24a and 24b are substantially impermeable to the toxins and/or odorous substances emitted by the lure 14. Accordingly, sealing the lure 14 within the chamber 62 helps prevent exposing people to toxic fumes and/or unpleasant odors from the lure 14 prior to severing the bond 60 to deploy the insect-attraction apparatus 10.

In additional embodiments of the present invention, an adhesive may be disposed in the locations represented by the bonds 58 and 60 instead of using a heat-sealing process. For example, the sheet 18 may be made from a flexible plastic material and the chamber 62 may be formed by joining the interior surfaces 24a and 24b with an adhesive applied to one or both of the interior surfaces 24a and 24b of the sheet 18.

The insect-attraction apparatus 10 illustrated in FIGS. 6A and 6B is shown in a storage configuration, with the bonds 58 and 60 being formed. Accordingly, the insect-attraction apparatus 10 shown in FIGS. 6A and 6B may be readily stacked and packaged with hundreds of other similarly packaged insect-attraction apparatuses 10. Except for a wire or hook for hanging the insect-attraction apparatus 10, the insect-attraction apparatus 10 may be deployed without requiring any other component. The technician or user may sever the bond 60 bonding the interior surfaces 24a and 24b of the sheet 18 of the housing 16 together by manually pulling the interior surfaces 24a and 24b apart. Then, the technician or user expands the housing 16 to configure the housing 16 in the deployment configuration, with the passageway 15 allowing access to the lure 14. The perforations 50a-50c may also be manually broken to allow the tabs 30a and 30b to deployed, when desired. In one embodiment of the present invention, after expanding the housing 16 into the deployment configuration, a strip of material including insecticide may be attached to one of the interior surfaces 24a and 24b (e.g., by stapling) of the housing 16. Accordingly, the insect-attraction apparatus 10 may be deployed in the field without requiring assembling a number of different components. Consequently, the insect-attraction apparatus 10 does not require a significant amount of packaging material because, as shown in FIG. 6B, the folded sheet 18 that encloses the lure 14 may function as the packaging material that substantially seals the lure within the chamber 62.

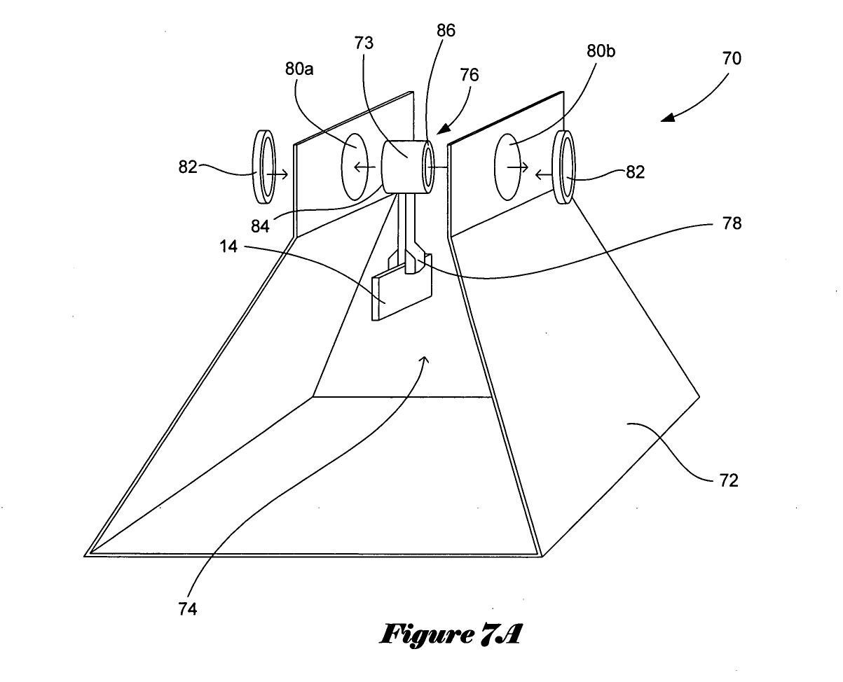

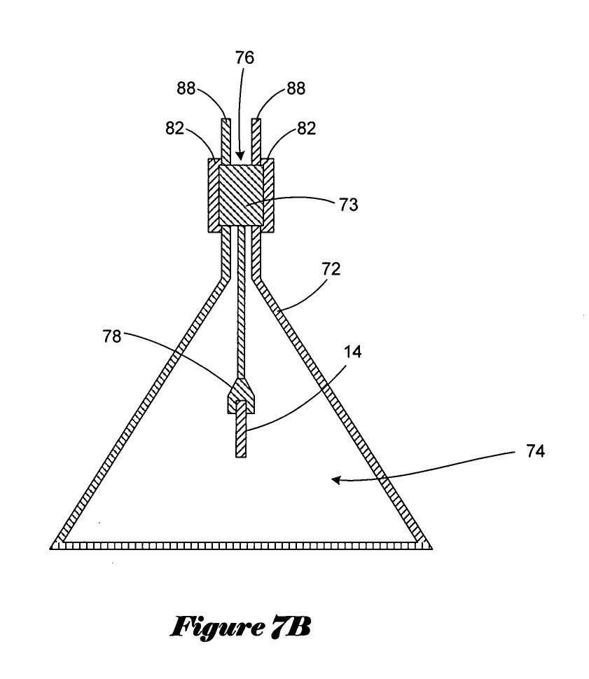

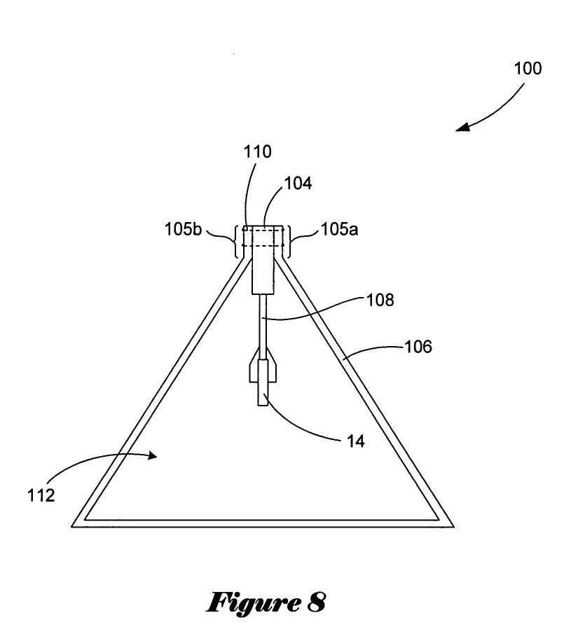

FIGS. 7A-7B and 8 show various embodiments of the present invention that may be used for supporting the lure 14 within a chamber when the insect-attraction apparatus is in a storage configuration and supporting the lure 14 within a passageway that accesses the lure 14 when the insect-attraction apparatus is in a deployment configuration. FIGS. 7A and 7B shows an insect-attraction apparatus 70 that includes a housing 72 that is similar in construction to the housing 16 shown in FIG. 1. The housing 72 defines a passageway 74 allowing access to the lure 14 positioned within the passageway 74. The insect-attraction apparatus 70 further includes a lure-support device 76 having a shaft portion 73 at one end and a gripping member 78 extending from the shaft portion 73 into the passageway 74. The gripping member 78 is configured for holding the lure 14. The gripping member 78 may include one or more spring biased arms that grip the lure 14 or may grip the lure 14 due to an interference fit with the lure 14. The lure-support device 76 may be held in position by inserting opposing ends 84 and 86 of the shaft portion 73 through holes 80a and 80b formed in a top portion 88 of the housing 72. After inserting the shaft portion 73 into the holes 80a and 80b, retention members 82 are attached to the ends 84 and 86 of the shaft portion 73 to retain the lure-support device 76 on the housing 72. For example, the retention members 82 may snap-fit or screw onto the shaft portion 73.

FIG. 8 shows yet another embodiment of an insect-attraction apparatus 100 that includes a lure-support device 102 according to the present. The lure-support device 102 may be a molded-plastic piece that includes a generally planar attachment portion 104. The attachment portion 104 is sandwiched in between opposing portions 105a and 105b of a housing 106. A support arm 108 may extend from the attachment portion 104 and grip the lure 14 to position the lure 14 within a passageway 112 of the housing 106. The lure-support device 102 may be attached to the housing 106 by inserting one or more staples 110 through the portions 105a and 105b of the housing 106 and the attachment portion 104.

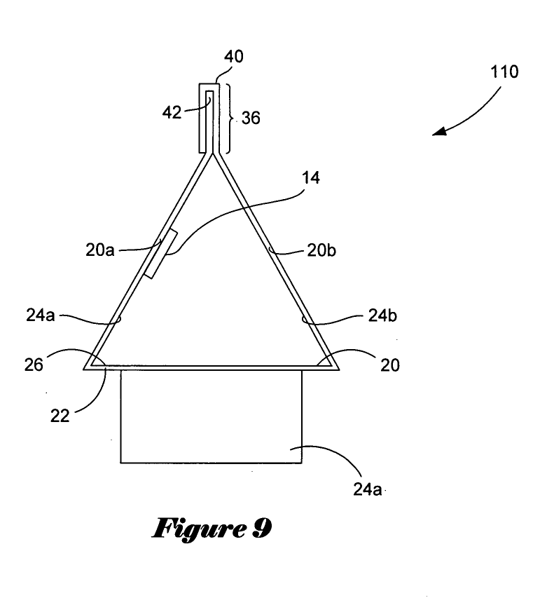

A variety of adaptations of the above embodiments of the present invention for the supporting the lure 14 may be used. For example, the string 34 (FIG. 2A), the lure-support device 76 (FIG. 7A), and the lure-support device 102 (FIG. 8) may be omitted. FIG. 9 shows one embodiment of an insect-attraction apparatus 110 according to the present invention that omits a lure-support device. The insect-attraction apparatus 110 is a variation of the insect-attraction apparatus 10 shown in FIGS. 1 and 2A-2B. As shown in FIG. 9, the lure 14 may be positioned within the passageway 15 by attaching the lure 14 to one of the first and second interior surfaces 24a and 24b of the housing 16. Prior to folding the sheet 18 to substantially seal the lure 14, the lure 14 may be attached to one of the first and second interior surfaces 24a and 24b using a suitable adhesive or a mechanical attachment mechanism. After attaching the lure 14 to one of the first and second interior surfaces 24a, the first and second interior surfaces 24a and 24b are bonded together, as previously described, to form a chamber receiving the lure 14.

Although the present invention has been described in terms of particular embodiments, it is not intended that the present invention be limited to these embodiments. Modifications within the spirit of the present invention will be apparent to those skilled in the art. For example, although flying insects are discussed in the above embodiments, the disclosed insect-attraction apparatuses may also be used to attract non-flying insects. Additionally, the structure of the housings of the illustrated embodiments may be altered. For example, the base 22 of the housing 16 shown in FIGS. 1 and 2A-2B may be eliminated. In such an embodiment, the lure 14 may still be sealed within a chamber. However, after severing the bond that forms the chamber to deploy the insect-attraction apparatus, the housing does not have a base and the lure 14 may be enclosed by sidewalls. Other variations for the structure of the housing may be used.

The foregoing description, for purposes of explanation, used specific nomenclature to provide a thorough understanding of the present invention. However, it will be apparent to one skilled in the art that the specific details are not required in order to practice the present invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the present invention and its practical applications, to thereby enable others skilled in the art to best utilize the invention and various embodiments with various modifications as are suited to the particular use contemplated. It is intended that the scope of the present invention be defined by the following claims and their equivalents:

1. An insect-attraction apparatus, comprising:
a lure including an insect-attractive substance;
a housing including a chamber with the lure positioned inside the chamber, the chamber partially defined by a bond between interior surfaces of the housing; and
when the bond between the interior surfaces of the housing is severed, the housing is expandable to form a passageway that allows access to the lure.

2. The insect-attraction apparatus of claim 1 wherein the bond and the interior surfaces of the housing define the chamber, and further wherein the bond and the interior surfaces of the housing are substantially impermeable to substances emitted by the lure.

3. The insect-attraction apparatus of claim 1 wherein the bond comprises a heat-sealed bond.

4. The insect-attraction apparatus of claim 1 wherein the bond comprises an adhesive disposed between the interior surfaces of the housing.

5. The insect-attraction apparatus of claim 1 wherein the passageway has one of:
a generally triangular cross-sectional geometry;
a generally rectangular cross-sectional geometry;
a generally diamond cross-sectional geometry; and
a generally circular cross-sectional geometry.

6. The insect-attraction apparatus of claim 1 wherein the housing comprises a base that partially defines the passageway, the base including an opening formed through a thickness of the base.

7. The insect-attraction apparatus of claim 6 wherein the base comprises tabs configured to be folded in a direction away from the lure to open the opening.

8. The insect-attraction apparatus of claim 1 wherein the housing comprises sidewall members that partially define the passageway and further wherein the housing does not include a base.

9. The insect-attraction apparatus of claim 1, further comprising an insect-capture sheet positioned adjacent the base within the passageway.

10. The insect-attraction apparatus of claim 1 wherein the housing comprises one of:
paperboard;
cardboard;
polymeric material;
a composite material; and
a metallic material.

11. The insect-attraction apparatus of claim 1, further comprising at least one of:
a serial number positioned on the housing;
a date-entry region positioned on the housing;
a location-entry region positioned on the housing; and
a time-entry region positioned on the housing.

12. The insect-attraction apparatus of claim 1, further comprising a lure-support device that supports the lure within the passageway.

13. The insect-attraction apparatus of claim 12 wherein the lure-support device comprises a flexible member that is attached to the lure and the housing.

14. The insect-attraction apparatus of claim 12 wherein the lure-support device is attached to the housing using one or more staples.

15. The insect-attraction apparatus of claim 12 wherein the lure-support device comprises a gripping mechanism configured to grip the lure.

16. The insect-attraction apparatus of claim 1 wherein the lure is mounted to one of the interior surfaces of the housing.

17. The insect-attraction apparatus of claim 1 wherein the insect-attractive substance comprises an insecticide.

18. The insect-attraction apparatus of claim 1, further comprising an insecticide attached to one of the interior surfaces of the housing.

19. A method of fabricating an insect-attraction apparatus, the method comprising:
providing a sheet including a number of fold lines;
positioning a lure containing an insect-attractive substance on or above the sheet;
folding the sheet along the fold lines to sandwich the lure between a first surface of the sheet and an opposing second surface of the sheet; and
bonding the first and second surfaces to form a chamber, with the lure positioned inside of the chamber.

20. The method of claim 19 wherein bonding the first and second surfaces to form a chamber comprises heat-sealing the first and second surfaces together.

21. The method of claim 19 wherein bonding the first and second surfaces to form a chamber comprises bonding the first and second surfaces together using an adhesive placed between the first and second surfaces.

22. The method of claim 19 wherein bonding the first and second surfaces to form a chamber comprises bonding the first and second surfaces along a region extending about the lure.

23. The method of claim 19 wherein positioning a lure containing an insect-attractive substance on or above the sheet comprises mounting the lure to one of the first and second surfaces of the sheet.

24. The method of claim 19, further comprising:
prior to folding the sheet along the fold lines, attaching the lure to the sheet.

25. A method of deploying an insect-attraction apparatus, the method comprising:
providing the insect-attraction apparatus, the insect-attraction apparatus comprising a lure containing an insect-attractive substance and a housing including a chamber partially defined by a bond between opposing interior surfaces of the housing, with the lure being positioned inside the chamber;
severing the bond between the opposing interior surfaces;
expanding the housing so that the housing defines a passageway that accesses the lure.

26. The method of claim 25:
wherein the housing comprises a base including perforations partially outlining tabs;
further comprising:
after expanding the housing, breaking the perforations; and
after breaking the perforations, moving the tabs in a direction away from the lure to form an opening through the base.

27. The method of claim 25:
wherein the housing comprises a base including perforations outlining tabs;
further comprising:
after expanding the housing, removing the tabs from the base by breaking the perforations to form an opening through the base.

28. The method of claim 25 wherein the passageway has one of:
a generally triangular cross-sectional geometry;
a generally rectangular cross-sectional geometry;
a generally diamond cross-sectional geometry; and
a generally circular cross-sectional geometry.
